(19) United States
(12) Patent Application Publication
(10) Pub. No.: US 2024/0002119 A1
(43) Pub. Date: Jan. 4, 2024

(54) PACKAGING SYSTEM WITH CONTROLLED RELEASE OF ACTIVE AGENT

(71) Applicant: SoFresh, Inc., Pleasant Prairie, WI (US)

(72) Inventors: William P. BELIAS, Pittsford, NY (US); Toby R. THOMAS, Pleasant Prairie, WI (US); David V. DOBRESKI, Canandaigua, NY (US)

(73) Assignee: SoFresh, Inc., Pleasant Prairie, WI (US)

(21) Appl. No.: 18/252,474

(22) PCT Filed: Nov. 17, 2021
(86) PCT No.: PCT/US2021/072474

§ 371 Date: May 10, 2023

Related U.S. Application Data
(60) Provisional application No. 63/115,510, filed on Nov. 18, 2020.

(51) Int. Cl. B65D 65/40; B65D 77/00; B65D 85/36; B65D 75/00; B65D 81/28; B32B 27/32; B32B 27/30; B32B 27/08; B32B 27/22; B32B 7/02

(52) U.S. Cl. CPC B65D 65/40; B65D 77/003; B65D 85/36; B65D 75/00; B65D 81/28; B32B 27/32; B32B 27/306; B32B 27/08; B32B 27/22; B32B 7/02; B65D 2565/387; B32B 2439/46; B32B 2307/7376; B32B 2270/00; B32B 2439/70; B32B 2307/728; B32B 2307/7246; B32B 2307/7244; B32B 2250/246

(57) ABSTRACT

Provided herein are packaging systems suitable for storing products, such as food products. The packaging systems are made up of multilayer film constructions that provide controlled release of an active agent at a point in time that is past the manufacturing of the packaging systems but coincides with their functional use (e.g., at the food packaging step). The multilayer film constructions have a composition that is sensitive to humidity, which converts the constructions from a barrier to a transmitter of the active agent loaded within multilayer film constructions.

### CROSS-REFERENCE TO RELATED APPLICATIONS

This application claims priority to and the benefit of U.S. Provisional Application No. 63/115,510, filed on Nov. 18, 2020, the entire disclosure of which is incorporated herein by reference in its entirety.

### FIELD

The present disclosure relates generally to packaging materials, and more specifically to packaging systems for storing a humidity-inducing product, such as a food product. The packaging systems are made from multilayer film constructions containing active agent that begins to release towards the interior space of the system in the presence of a humidity-inducing product.

### BACKGROUND

Polymeric films, such as polyethylene or polypropylene films, are common packaging materials. They are often coextruded with other polymeric materials into multilayer films for various purposes. One such purpose is to create packaging materials that can be used to store food. One type of food is red muscle meat, which is often preserved under low oxygen. Other polymeric films are designed to reduce the transmission of moisture that can store foods sensitive to moisture or foods that need to retain moisture, such as baked goods. Another class of films can be loaded with antimicrobial additives that can extend the shelf life of fresh foods. This class of packaging materials has an additional requirement to dispense the antimicrobial additive at the appropriate time without losing potency during the period between production and use.

One method of shelf life extension is to impregnate polymeric film substrates with a volatile organic liquid that has antimicrobial properties. The antimicrobial volatilizes into the packaged food space to prevent the proliferation of microbes, such as bacteria and mold. However, what is desired in the art is to have the volatile organic liquid stay in the film reservoir until the time of use, such as the packaging step of the food.

In particular, one technical problem that this present disclosure seeks to address is the controlled release of the volatile organic liquid in the packaging material. If the release of the volatile organic liquid is not properly controlled, volatile organic liquid may be released into the packaging facility and accumulate, which presents health hazards, and the premature loss of the volatile organic liquid from the packaging system can decrease overall efficacy of the packing system.

### BRIEF SUMMARY

In some aspects, provided is a packaging system for storing a humidity-inducing product. The packaging systems described herein solve the technical problem describe above, by using combinations of materials chosen and designed to control the release of the active agent present in the system. The release of the active agent is based on moisture level and/or relative humidity. For example, when the interior space of the packaging system has a certain moisture level, or the interior space has a relative humidity greater than ambient humidity surrounding the exterior of the system, active agent is released into the interior space in a controlled manner.

In some embodiments, the packaging system comprises at least two multilayer film constructions. In some embodiments, the packaging system comprises active agent. In some embodiments, the multilayer film constructions are configured to provide an interior space around the humidity-inducing product. For example, the packaging system may be in the form of a pouch.

In some embodiments, each multilayer film construction independently comprises core structural layers. In some embodiments, the core structural layers comprise material that is permeable to the active agent at any humidity and/or temperature. In some embodiments, each multilayer film construction independently comprises barrier activation layers. In some embodiments, at least some of the barrier activation layers are moisture-sensitive layers that are in contact with the core structural layers. In some embodiments, each multilayer film construction independently comprises an active agent. In some embodiments, the active agent comprises at least one volatile compound in liquid form. In some embodiments, the active agent is distributed at the interface between adjacent core structural layers within each multilayer film construction. In some embodiments, in the absence of the humidity-inducing product present in the interior space, the active agent does not substantially permeate into the interior space. In some embodiments, the multilayer film constructions do not require the presence of ablations to control the release of the active agent into the interior space when the humidity-inducing product is present in the interior space. In some embodiments, when (i) the interior space has a moisture level of at least 60% relative humidity, or (ii) the interior space has a relative humidity greater than ambient humidity surrounding the exterior of the system, or both (i) and (ii), the barrier activation layers between the active agent and the interior space lose their barrier properties to the active agent over time, thereby releasing the active agent to the interior space.

In some embodiments, the active agent comprises ethyl pyruvate. In some embodiments, the core structural layers independently comprise polyethylene or polypropylene, or a combination thereof. In some embodiments, the moisture-sensitive layers independently comprise ethylene vinyl alcohol or polyvinyl alcohol, or a combination thereof. In some embodiments, the moisture-sensitive layers comprise polyvinyl alcohol, wherein the polyvinyl alcohol is plasticized with one or more hydrophilic materials. In some embodiments, the one or more hydrophilic materials comprise glycerol or water. In some embodiments, the moisture-sensitive layers comprises ethylene vinyl alcohol, wherein the ethylene vinyl alcohol comprises between 20 mole % and 40 mole % ethylene.

In some embodiments, the active agent comprises ethyl pyruvate. In some embodiments, the core structural layers independently comprise polyethylene. In some embodiments, the moisture sensitive layers independently comprise ethylene vinyl alcohol or polyvinyl alcohol, or a combination thereof.

In some embodiments, the system further comprises a tray holding the product. In some embodiments, the multilayer film construction is wrapped around the tray and the product. In some embodiments, the system further comprises a container holding the product, wherein the multilayer film construction forms a lid to the container. In some embodiments, the container is a rigid container. In some embodiments, the system is a pouch. In some embodiments,

In some embodiments, the outermost barrier activation layer and the innermost barrier activation layer of the multilayer film construction are amphiphilic compatibilizer layers. In some embodiments, the outermost barrier activation layer and the innermost barrier activation layer of the multilayer film construction are additional layers comprising material permeable to the active agent at any humidity and/or temperature. In some embodiments, the outermost barrier activation layer and the innermost barrier activation layer of the multilayer film construction comprise polyethylene. In some embodiments, (i) the outermost barrier activation layer has an average thickness between 0.00001 inches and 0.001 inches, or (ii) the innermost barrier activation layer has an average thickness between 0.00025 inches and 0.003 inches, or both (i) and (ii). In some embodiments, the outermost barrier activation layer has an average thickness between 0.00001 inches and 0.001 inches, and the innermost barrier activation layer has an average thickness between 0.00025 inches and 0.003 inches. In some embodiments, the additional layers and the core structural layers have substantially the same average thickness.

In some embodiments, at least some other of the barrier activation layers are amphiphilic compatibilizer layers that are positioned between core structural layers and moisture-sensitive layers, such that the core structural layers adhere to the moisture-sensitive layers. In some embodiments, at least some other of the barrier activation layers are amphiphilic compatibilizer layers that are positioned between core structural layers and moisture-sensitive layers and/or between moisture-sensitive layers and the additional layers, such that the core structural layers adhere to the moisture-sensitive layers and/or the moisture-sensitive layers adhere to additional layers. In some embodiments, the amphiphilic compatibilizer layers comprise maleic anhydride copolymer. In some embodiments, the amphiphilic compatibilizer layers further comprise material that is permeable to the active agent at any humidity and/or temperature. In some embodiments, the amphiphilic compatibilizer layers independently comprise a blend of maleic anhydride copolymer and polyethylene. In some embodiments, the amphiphilic compatibilizer layers have an average thickness between 1 micron and 10 microns.

In some embodiments, the moisture-sensitive layers have an average thickness between 0.5 microns and 25 microns. In some embodiments, The system of any one of the preceding claims, wherein the average thickness of the barrier activation layers combined is at least 1% of the overall average thickness of the system. In some embodiments, the core structural layers have an average thickness between 5 microns and 75 microns.

In some embodiments, The system of any one of the preceding claims, wherein the moisture-sensitive layers comprise nanomers. In some embodiments, nanomers have plate-like structures. In some embodiments, at least some of the nanomers are Montmorillonite inorganic clay. In some embodiments, at least some of the nanomers are precoated.

In some embodiments, the average ambient humidity surrounding the exterior of the system is between 50% and 70%. In some embodiments, the active agent is released to the interior space of the system at a migration rate that is greater than the migration rate at which active agent is released to the surrounding exterior to the system. In some embodiments, the barrier activation layers between the active agent and the interior space lose their barrier properties to the active agent over time, thereby releasing the active agent to the interior space when the relative humidity of the interior space is 10% or more higher than the ambient humidity surrounding the exterior of the system. In some embodiments, the active agent is released into the interior space of the system at a migration rate of at least 0.001 g of active agent/square meter per day. In some embodiments, the active agent is released into the interior space of the system at a migration rate of between 0.001 g and 10 g of active agent/square meter per day. In some embodiments, the active agent is released into the interior space at an average rate between 0.1 g/m²/day and 10 g/m²/day in the first 10 days when the interior space has a moisture level of at least 60% relative humidity. In some embodiments, the active agent is released into the interior space at an average rate between 1 mg/m²/day and 5 mg/m²/day in the first 10 days when the interior space has a moisture level of at least 99% relative humidity.

In some embodiments, the polyethylene is linear low-density polyethylene. In some embodiments, the multilayer film constructions are manufactured by a blown film process. In some embodiments, the product is a food product. In some embodiments, the food product is a bakery good, cheese or meat. In some embodiments, the food product is a loaf of bread.

### DESCRIPTION OF THE FIGURES

The present application can be best understood by reference to the following description taken in conjunction with the accompanying figures, in which like parts may be referred to by like numerals.

FIGS. 1, 2A and 2B depict exemplary packaging pouches to store food. The packaging pouches depicted are made from different exemplary multilayer film constructions. It should be understood that the thickness of the layers depicted in the figures are not to scale.

### DETAILED DESCRIPTION

The following description sets forth exemplary compositions, systems, methods, parameters and the like. It should be recognized, however, that such description is not intended as a limitation on the scope of the present disclosure but is instead provided as a description of exemplary embodiments.

Ethylene vinyl alcohol (EVOH) and polyvinyl alcohol (PVOH) are known barrier materials to organic volatile liquid materials. These polymers are often used in packaging films to reduce the permeability of oxygen. They are also known to have very poor resistance to moisture, which causes their loss of functional properties. The packaging systems described herein use EVOH and/or PVOH as moisture activated layers of polymeric films within multilayer film constructions. More specifically, when EVOH and/or PVOH are used in the packaging systems described herein, they can absorb moisture from the interior of the package and lose barrier properties in the presence of a humidity-inducing product, such as a food product.

The packaging systems described herein provide a programed release of active agents at a point in time that is past the manufacturing of the packaging systems but coincides with their functional use. The multilayer film constructions of the packaging systems herein have a composition that is sensitive to humidity, which converts the constructions from a barrier to a transmitter of the active agent.

In some aspects, provided is a packaging system comprising at least one multilayer film construction loaded with active agent having antimicrobial properties to extend the shelf life of the product stored in the packaging system. In some embodiments, provided is a packaging system comprising two multilayer film constructions loaded with the active agent. The multilayer film construction provides an interior space around the product stored in the packaging system.

For example, in certain embodiments, the packaging system is a pouch. In some variations, at least a portion of the sides of the pouch is sealed, and at least a portion of the sides of the pouch is unsealed to allow for insertion of the product into the pouch. In certain variations, at least a portion of the pouch is made from the multilayer film construction described herein, and the remaining portions of the pouch is made from other materials.

In other embodiments, the packaging system also includes a tray that holds the product, and the multilayer film construction is wrapped around the tray and the product. In yet other embodiments, the packaging system also includes a container that holds the product, and the multilayer film construction forms a lid to the container. In some variations, the container is a rigid container.

When the packaging system holds a humidity-inducing product, the moisture level in the interior of the packaging system increases. The active agent loaded in the multilayer film constructions is released towards the interior of the packaging system when:
(i) the moisture level in the interior space of the packaging system reaches at least 60%, at least 65%, at least 70%, at least 75%, at least 80%, at least 85%, at least 90%, or at least 95% relative humidity, or between 60% and 100%, between 70% and 100%, between 80% and 100%, between 85% and 100%, between 90% and 100%, between 95% and 100%, or between 95% and 99% relative humidity; or
(ii) the relative humidity in the interior of the packaging system is greater than the ambient humidity surrounding the exterior of the packaging system; or
(iii) the relative humidity in the interior of the packaging system is at least 20%, at least 25%, at least 30%, at least 35%, at least 40%, or at least 50% greater than the ambient humidity surrounding the exterior of the packaging system,
or any combination of (i)-(iii).

The packaging systems described herein may be used to store humidity-inducing products, such as food products. Suitable food products may include, for example, bakery products, cheese products or meat products. In one variation, the product is bread, or more specifically, a loaf of bread.

The packaging systems, including the multilayer film constructions, as well as the uses and manufacturing process to produce the packaging systems are described in further detail below.

### Multilayer Film Constructions

In some aspects, provided is a multilayer film construction comprising core structural layers and barrier activation layers. Generally, the core structural layers exist to provide tensile strength or for thickness. One main property the core structural layer brings is transparency. The barrier activation layers are functional layers that may be an adhesive, barrier, transmission and/or surface property layer. Surface properties include, for example, slip level and surface energy and anti-block.

In some embodiments, the active agent is distributed at the interface between adjacent core structural layers within each multilayer film construction. In some embodiments, the packaging system is designed so that the core/structural/transmission/adhesion layers are positioned next to the active agent, and the functional/barrier/transmission layers are positioned further from the active agent.

When conditions surrounding the packaging system change (e.g., the moisture level in the interior space of the packaging system increases), the active agent evaporates and diffuses towards in vapor form the interior space of the packaging system. The packaging systems described herein do not require ablations through multiple layers to release the active agent into the interior space of the packaging system.

Core Structural Layers

The cores structural layers give the packaging system strength. In some embodiments, the core structural layers comprise material that is permeable to the active agent at any humidity and/or temperature. In some embodiments, the core structural layers comprise polyolefin. In certain embodiments, the core structural layers comprise polyethylene. In some variations, the polyethylene is low-density polyethylene (LDPE) or linear low-density polyethylene (LLDPE), or a combination thereof. In one variation, the polyethylene is LLDPE.

Barrier Activation Layers

The barrier activation layers include various types of layers that contribute to the controlled release of the active agent in the multilayer film construction. In some embodiments, at least some of the barrier activation layers are moisture-sensitive functional layers. Over time, moisture causes these layers to lose their barrier properties to the active agent, thereby allowing the active agent to diffuse through these layers. In certain embodiments, the moisture-sensitive functional layers are in contact with the core structural layers, but are separated from (or not in contact with) the active agent in liquid form. In certain variations, the moisture-sensitive functional layers independently comprise ethylene vinyl alcohol (EVOH), polyvinyl alcohol (PVOH), starch, cellulose acetate, polyester, nylon (e.g., nylon 6 or nylon 6/6), or any combination thereof. In one variation, the moisture-sensitive functional layers comprise EVOH.

In some embodiments, the moisture-sensitive layers comprise polyvinyl alcohol. In some embodiments, the polyvinyl alcohol is plasticized with one or more hydrophilic materials. In some embodiments, the one or more hydrophilic materials comprise glycerol or water.

In some embodiments, the moisture-sensitive layers comprise ethylene vinyl alcohol. In some embodiments, the ethylene vinyl alcohol comprises between 1 mole % and 50 mole %; 5 mole % and 50 mole %; 10 mole % and 40 mole %; 15 mole % and 40 mole %; 20 mole % and 40 mole %; 20 mole % and 35 mole %; 25 mole % and 35 mole %; or 25 mole % and 30 mole % ethylene.

In certain embodiments, the barrier activation layers may further include amphiphilic compatibilizer layers. In some variations, the amphiphilic compatibilizer layers are positioned between core structural layers and moisture-sensitive functional layers. The amphiphilic compatibilizer layers help make the core structural layers more compatible with the moisture-sensitive functional layers, both in terms of creating adhesion at the interface between the core structural layers and the moisture-sensitive functional layers, as well as changing the permeability of the moisture-sensitive functional layer with respect to the active agent. In certain variations, the amphiphilic compatibilizer layers comprise maleic anhydride copolymer, and optionally material that is permeable to the active agent at any humidity and/or temperature. For example, in one variation, the amphiphilic compatibilizer layers comprise a blend of maleic anhydride copolymer and polyethylene.

In yet other embodiments, the barrier activation layers may further include a thin layer comprising material permeable to the active agent at any humidity and/or temperature as the outermost barrier activation layer and the innermost barrier activation layer of the multilayer film construction.

In some embodiments, the outermost barrier activation layer and the innermost barrier activation layer of the multilayer film construction are additional layers comprising material permeable to the active agent at any humidity and/or temperature. In some embodiments, the outermost barrier activation layer and the innermost barrier activation layer of the multilayer film construction comprise polyethylene. In some embodiments, (i) the outermost barrier activation layer has an average thickness between 0.00001 inches and 0.001 inches, or (ii) the innermost barrier activation layer has an average thickness between 0.00025 inches and 0.003 inches, or both (i) and (ii). In some embodiments, the outermost barrier activation layer has an average thickness between 0.00001 inches and 0.001 inches, and the innermost barrier activation layer has an average thickness between 0.00025 inches and 0.003 inches.

In some embodiments, the outermost barrier activation layer has an average thickness between 0.1 μm and 100 μm; between 1 μm and 100 μm; between 5 μm and 50 μm; between 10 μm and 50 μm; between 10 μm and 40 μm; between 15 μm and 35 μm; or between 20 μm and 30 μm.

In some embodiments, the additional layers and the core structural layers have substantially the same average thickness. In some embodiments, curling of the film can be reduced when the additional layers and the core structural layers have substantially the same average thickness.

In some embodiments, at least some other of the barrier activation layers are amphiphilic compatibilizer layers that are positioned between core structural layers and moisture-sensitive layers, such that the core structural layers adhere to the moisture-sensitive layers. In some embodiments, at least some other of the barrier activation layers are amphiphilic compatibilizer layers that are positioned between moisture-sensitive layers and the additional layers, such that the moisture-sensitive layers adhere to additional layers. In some embodiments, at least some other of the barrier activation layers are amphiphilic compatibilizer layers that are positioned between core structural layers and moisture-sensitive layers and/or between moisture-sensitive layers and the additional layers, such that the core structural layers adhere to the moisture-sensitive layers and/or the moisture-sensitive layers adhere to additional layers.

In some embodiments, the amphiphilic compatibilizer layers comprise maleic anhydride copolymer. In some embodiments, the amphiphilic compatibilizer layers further comprise material that is permeable to the active agent at any humidity and/or temperature. In some embodiments, the amphiphilic compatibilizer layers independently comprise a blend of maleic anhydride copolymer and polyethylene. In some embodiments, the amphiphilic compatibilizer layers have an average thickness between 1 micron and 10 microns.

In some embodiments, the moisture-sensitive layers have an average thickness between 0.5 micron and 25 microns. In some embodiments, the average thickness of the barrier activation layers combined is at least 1% of the overall average thickness of the system. In some embodiments, the moisture-sensitive layers have an average thickness between 0.1 micron and 100 microns; between 0.1 micron and 50 microns; between 0.5 micron and 25 microns; between 0.5 micron and 10 microns; or between 1 micron and 5 microns.

In some embodiments, each of the core structural layers have an average thickness between 5 microns and 75 microns. In some embodiments, each of the core structural layers have an average thickness between 1 micron and 500 microns; between 1 micron and 100 microns; between 5 microns and 100 microns; between 5 microns and 75 microns; between 10 microns and 75 microns; or between 10 microns and 50 microns.

In some embodiments, the moisture-sensitive layers comprise nanomers. In some embodiments, the nanomers have plate-like structures. In some embodiments, at least some of the nanomers are Montmorillonite inorganic clay. In some embodiments, at least some of the nanomers are precoated.

Active Agents

In some embodiments, the active agent comprises at least one volatile compound in liquid form. In some variations, the active agent comprises organic volatile liquid (OVL) or volatile organic compounds (VOC). In some variations, the active agent used in the packaging systems described herein inhibit the growth of various fungi, bacteria, and/or insects. In some variations, the active agent used in the packaging systems described herein are suitable for human consumption.

In certain embodiments, the active agent suitable for use in the packaging systems described herein have one or more of the following properties: (i) a vapor pressure at room temperature; (ii) a boiling point of less than 200° C.; (iii) can easily diffuse through materials described for the core structural layer, such as polyethylene or other polyolefins; and (iv) does not easily diffuse through the materials described for the moisture-sensitive functional layers, such as EVOH and PVOH.

In some variations, the active agent comprises alkyl pyruvate, carvacrol, thymol, eugenol, lemongrass oil, cinnamon essential oil, oregano essential oil, or cinnamaldehyde. In some variations, the alkyl pyruvate is a C₁₋₁₀ alkyl pyruvate. In some variations, the alkyl pyruvate is methyl pyruvate, ethyl pyruvate, or propyl pyruvate. In one variation, the active agent comprises ethyl pyruvate.

In some embodiments, any combination of the active agents described herein may be incorporated into the packaging systems herein.

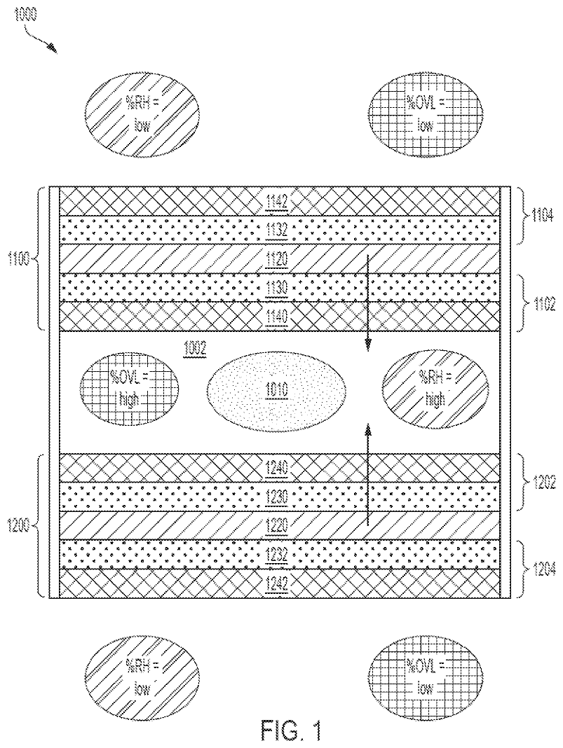

With reference to FIG. 1, an exemplary packaging system 1000 is depicted as a pouch. Pouch 1000 has two multilayer film constructions 1100 and 1200 that enclose product 1010 in interior space 1002. Suitable humidity-inducing products may include, for example, food products. Each multilayer film construction is made up of two multilayer sub-constructions, with active agent distributed between the two multilayer sub-constructions. For example, on multilayer film construction 1100 of the pouch, active agent 1120 is distributed in liquid form between multilayer sub-constructions 1102 and 1104, and specifically, between cores structural layers 1130 and 1132. Active agent 1120 is referred to in FIG. 1 as “OVL” or organic volatile liquid. Active agent 1120 may include any suitable agents as described herein.

Moisture-sensitive functional layers 1140 and 1142 are barrier activation layers that are in contact with cores structural layers 1130 and 1132, respectively. Similarly, on multilayer film construction 1200 of the pouch, active agent 1220 is distributed in liquid form between multilayer sub-constructions 1202 and 1204, and specifically, between cores structural layers 1230 and 1232. Moisture-sensitive functional layers 1240 and 1242 are barrier activation layers that are in contact with cores structural layers 1230 and 1232, respectively.

With reference again to FIG. 1, layers 1140 and 1240 are the innermost layers of pouch 1000; and layers 1142 and 1242 are the outermost layers of pouch 1000.

Product 1010 is a humidity-inducing product, such as a food product. When placed inside pouch 1000 as depicted in FIG. 1, the moisture level of interior space 1002 increases, thereby increasing the relative humidity inside the pouch. When the relative humidity inside the pouch is greater than the ambient humidity outside the pouch, active agents 1120 and 1220 will diffuse towards interior space 1002 at a migration rate that is greater than the migration rate of active agent diffusing towards the exterior of the pouch.

The migration of the active agent towards the interior space is depicted in FIG. 1 by the arrow. Any potential migration of the active agent towards the exterior of the pouch is not depicted in the figure, and in some variations, should be relatively lower (than migration of the active agent towards the interior space) or negligible. With reference to FIG. 1, on multilayer film construction 1100, the migration rate at which active agent 1120 diffuses through inner multilayer sub-construction 1102 is greater than the migration at which active agent 1120 diffuses through the outer multilayer sub-construction 1104, which may in certain conditions be negligible. Similarly, on multilayer film construction 1200, the migration rate at which active agent 1220 diffuses through inner multilayer sub-construction 1202 is greater than the migration at which active agent 1220 diffuses through the outer multilayer sub-construction 1204, which may in certain conditions be negligible. As a result, when relative humidity inside pouch 1000 increases, the percentage OVL will increase as the active agent diffuses towards the pouch interior.

While FIG. 1 depicts each multilayer sub-construction (e.g., 1102, 1104, 1202 and 1204) as having a single core structural layer and a single moisture-sensitive functional layer, it should be understood that in other variations, the multilayer film construction may have a plurality of core structural layers and/or a plurality of moisture-sensitive functional layers. For example, in one variation, a multilayer film construction may have between 1 and 20, between 1 and 15, between 1 and 10 core structural layers; or 2, 3, 4, 5, 6, 7, 8, 9, or 10 core structural layers.

Any suitable materials described herein for the active agent, core structural layers and the barrier activation layers may be employed. For example, in one exemplary embodiment of packaging system 1000, active agent 1120 comprises ethyl pyruvate; core structural layers 1130, 1132, 1230, and 1232 comprise LLDPE; and moisture-sensitive functional layers 1140, 1142, 1240, and 1242 comprise EVOH.

In other exemplary packaging systems, the multilayer film construction may include additional types of barrier activation layers to control the release of the active agent distributed within the multilayer film construction. In some embodiments, such additional barrier activation layers are amphiphilic compatibilizer layers.

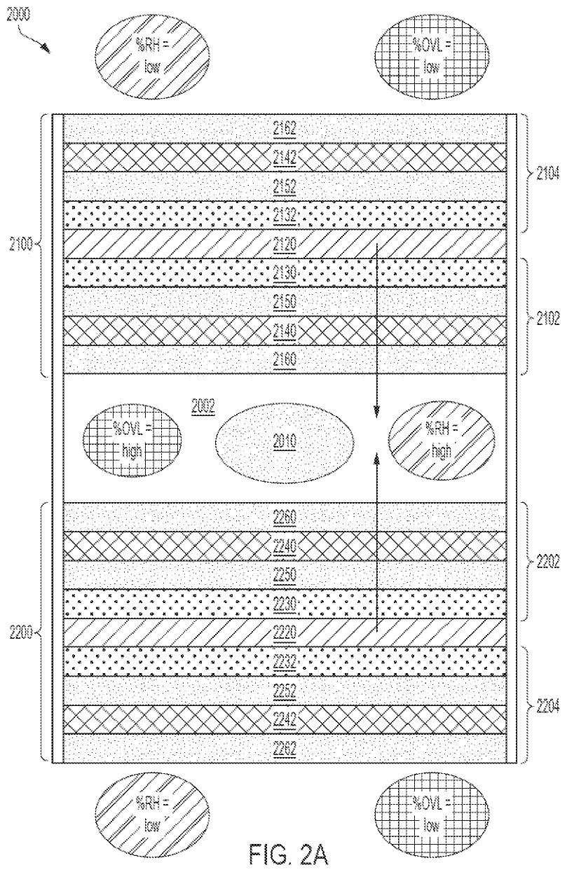

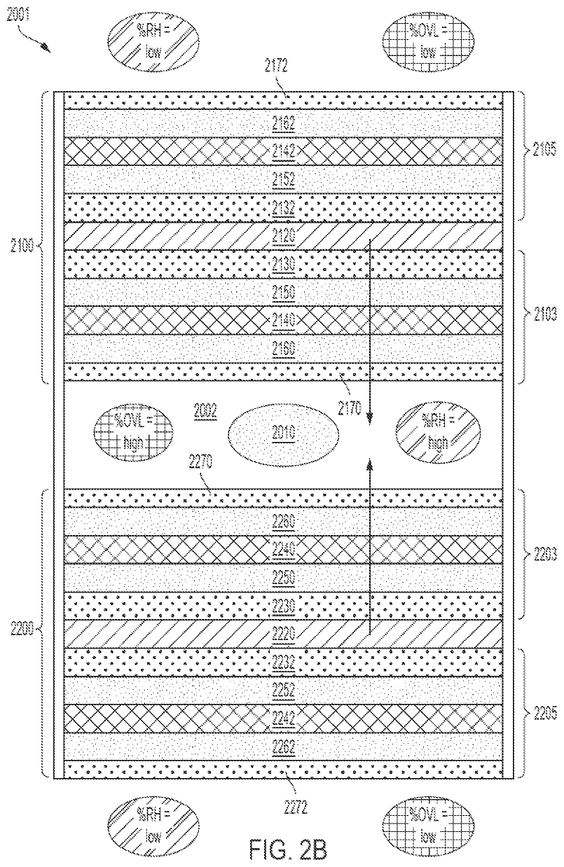

With reference to FIG. 2A, an exemplary packaging system 2000 is depicted as a pouch. Pouch 2000 has two multilayer film constructions 2100 and 2200 that enclose product 2010 in interior space 2002. Each multilayer film construction is made up of two multilayer sub-constructions, with active agent distributed between the two multilayer sub-constructions. For example, on multilayer film construction 2100 of the pouch, active agent 2120 is distributed in liquid form between multilayer sub-constructions 2102 and 2104, and specifically, between cores structural layers 2130 and 2132. Active agent 2120 is referred to once again as “OVL” or organic volatile liquid. Active agent 2120 may include any suitable agents as described herein.

Barrier activation layers include moisture-sensitive functional layers 2140 and 2142, and amphiphilic compatibilizer layers 2150, 2160, 2152 and 2162. The amphiphilic compatibilizer layers are positioned between core structural layers and moisture-sensitive functional layers, such that the core structural layers adhere to the moisture-sensitive functional layers. By way of illustration on multilayer film construction 2100, amphiphilic compatibilizer layer 2150 is positioned between core structural layer 2130 and moisture-sensitive functional layer 2140, which causes layers 2130 and 2140 to adhere, or at least partially adhere.

With reference again to FIG. 2A, amphiphilic compatibilizer layers 2160 and 2260 are the innermost layers of pouch 2000; and layers 2162 and 2262 are the outermost layers of pouch 2000.

Product 1010 is a humidity-inducing product, such as a food product. When product 2010 is placed inside pouch 2000, as depicted in FIG. 2A, the moisture level of interior space 2002 increases, thereby increasing the relative humidity inside the pouch. When the relative humidity inside the pouch is greater than the ambient humidity outside the pouch, active agents 2120 and 2220 will diffuse towards interior space 2002 at a migration rate that is greater than the migration rate of active agent diffusing towards the exterior of the pouch.

The migration of the active agent towards the interior space is depicted in FIG. 2A by the arrow. Any potential migration of the active agent towards the exterior of the pouch is not depicted in the figure, and in some variations, should be relatively lower (than migration of the active agent towards the interior space) or negligible. With reference to FIG. 2A, on multilayer film construction 2100, the migration rate at which active agent 2120 diffuses through inner multilayer sub-construction 2102 is greater than the migration at which active agent 2120 diffuses through the outer multilayer sub-construction 2104, which may in certain conditions be negligible. Similarly, on multilayer film construction 2200, the migration rate at which active agent 2220 diffuses through inner multilayer sub-construction 2202 is greater than the migration at which active agent 2220 diffuses through the outer multilayer sub-construction 2204, which may in certain conditions be negligible. As a result, when relative humidity inside pouch 2000 increases, the percentage OVL will increase as the active agent diffuses towards the pouch interior.

While FIG. 2A depicts each multilayer sub-construction (e.g., 2102, 2104, 2202 and 2204) as having a single core structural layer, a single moisture-sensitive functional layer, and single amphiphilic compatibilizer layers on either side of the moisture-sensitive functional layer, it should be understood that in other variations, the multilayer film construction may have a plurality of core structural layers, a plurality of moisture-sensitive functional layers, and/or a plurality of amphiphilic compatibilizer layers on either side of the moisture-sensitive functional layer(s). For example, in one variation, a multilayer film construction may have between 1 and 20, between 1 and 15, between 1 and 10 core structural layers; or 2, 3, 4, 5, 6, 7, 8, 9, or 10 core structural layers.

Any suitable materials described herein for the active agent, core structural layers and the barrier activation layers may be employed. For example, in one exemplary embodiment of packaging system 2000, active agent 2120 comprises ethyl pyruvate; core structural layers 2130, 2132, 2230, and 2232 comprise LLDPE; moisture-sensitive functional layers 2140, 2142, 2240, and 2242 comprise EVOH; and amphiphilic compatibilizer layers 2150, 2160, 2152 and 2162 comprise maleic anhydride copolymer, or a blend of maleic anhydride copolymer and polyethylene.

In certain variations where the multilayer film construction includes amphiphilic compatibilizer layers made entirely of maleic anhydride copolymer, such layers have an average thickness between 1 micron and 25 microns, between 2 microns and 25 microns, between 2 microns and 15 microns, between 2 microns and 10 microns, or between 1 micron and 5 microns.

In other variations where the multilayer film construction includes amphiphilic compatibilizer layers made up of a blend of maleic anhydride copolymer and polyethylene, the amphiphilic compatibilizer layers have an average weight ratio of polyethylene to maleic anhydride copolymer between 99.99:0.01 and 0.01:99.99. Such blended layers not only create pathways for moisture to migrate through, but also provide the appropriate adhesion for the core structural and the functional layers to adhere to each other.

In other embodiments, the multilayer film construction has an outermost layer and an innermost layer each comprising material that is permeable to the active agent at any humidity and/or temperature. These layers are typically thin layers that provide for similar surface properties as traditional films, such as slip and anti-blocking. The thickness of the outermost and innermost layers contribute to determining the rate of permeability of the active agent, based on the hydration of the functional layer from the interior. In some variations of the foregoing, the outermost layer is between 0.00001 inches and 0.001 inches, and/or the innermost layer is between 0.00025 inches and 0.003 inches.

With reference to FIG. 2B, another exemplary packaging system 2001 is depicted as a pouch. Pouch 2001 shares a similar construction as pouch 2000, except each multilayer sub-construction 2103 and 2105 (for multilayer film construction 2100) and 2203 and 2205 (for multilayer film construction 2200) has additional barrier activation layers. Specifically, pouch 2001 has additional barrier activation layers 2170 and 2270 as the innermost layers of the pouch, and 2172 and 2272 as the outermost layers of the pouch. Any of the other variations described herein for pouch 2000 in FIG. 2A also apply to pouch 2001 in FIG. 2B.

The migration of the active agent towards the interior space is depicted in FIG. 2B by the arrow. Any potential migration of the active agent towards the exterior of the pouch is not depicted in the figure, and in some variations, should be relatively lower (than migration of the active agent towards the interior space) or negligible. With reference to FIG. 2B, on multilayer film construction 2100, the migration rate at which active agent 2120 diffuses through inner multilayer sub-construction 2103 is greater than the migration at which active agent 2120 diffuses through the outer multilayer sub-construction 2105, which may in certain conditions be negligible. Similarly, on multilayer film construction 2200, the migration rate at which active agent 2220 diffuses through inner multilayer sub-construction 2203 is greater than the migration at which active agent 2220 diffuses through the outer multilayer sub-construction 2205, which may in certain conditions be negligible. As a result, when relative humidity inside pouch 2000 increases, the percentage OVL will increase as the active agent diffuses towards the pouch interior.

Any suitable materials described herein for the active agent, core structural layers and the barrier activation layers may be employed. For example, in one exemplary embodiment of packaging system 2001, active agent 2120 comprises ethyl pyruvate; core structural layers 2130, 2132, 2230, and 2232 comprise LLDPE; moisture-sensitive functional layers 2140, 2142, 2240, and 2242 comprise EVOH; amphiphilic compatibilizer layers 2150, 2160, 2152 and 2162 comprise maleic anhydride copolymer, or a blend of maleic anhydride copolymer and polyethylene; and additional barrier activation layers 2170, 2172, 2270 and 2272 comprise polyethylene.

It should be understood that the packaging pouches contemplated herein may contain one or more additional or different features. For example, while FIGS. 1, 2A and 2B depict two sides of a pouch both made from multilayer film constructions, in other variations, one of the two sides of the pouch may be made from other suitable polymeric and other materials. Using exemplary pouch 1000 in FIG. 1 to illustrate this point, pouch 1000 may be modified such that multilayer film construction 1100 is made from multilayer sub-constructions 1102 and 1104 as depicted, but multilayer film construction 1200 is replaced with other suitable packaging materials.

In some embodiments of the packaging systems described herein (including in the exemplary packaging systems depicted in FIGS. 1, 2A and 2B), the active agent diffuses to the interior of the packaging system at a migration rate of at least 0.001 g of active agent/square meter per day; or between 0.001 g and 10 g of active agent/square meter per day.

In some embodiments, the active agent is released into the interior space at an average rate between 0.1 g/m²/day and 10 g/m²/day in the first 10 days when the interior space has a moisture level of at least 60% relative humidity. In some embodiments, the active agent is released into the interior space at an average rate between 0.1 g/m²/day and 10 g/m²/day; between 0.5 g/m²/day and 7.5 g/m²/day; between 1 g/m²/day and 5 g/m²/day; between 2 g/m²/day and 4 g/m²/day; or between 2.5 g/m²/day and 3.5 g/m²/day in the first 10 days when the interior space has a moisture level of at least 60%; at least 70%; at least 80%; at least 90%; at least 95%; or at least 99% relative humidity. In some embodiments, the active agent is released into the interior space at an average rate between 1 mg/m²/day and 5 mg/m²/day in the first 10 days when the interior space has a moisture level of at least 99% relative humidity.

In some embodiments, the barrier activation layers between the active agent and the interior space lose their barrier properties to the active agent over time, thereby releasing the active agent to the interior space when the relative humidity of the interior space is 10% or more higher than the ambient humidity surrounding the exterior of the system.

Depending on the application, there are optimum thicknesses for each layer that provide the necessary performance. Packaging films have traditionally addressed moisture and oxygen permeability, as well as mechanical performance to hold and protect food. The packaging systems described herein have added additional variables that activate the release of active agent at the appropriate time (e.g., manufacturing of the packaging systems but coincides with their functional use, such as at the food packaging step), and allow the active agent to migrate at the appropriate rate.

Generally, increasing the permeability of the active agent towards the humidity-inducing product allows for quick dispensing of the active agent into the atmosphere surrounding the product, but also increases the loss of active agent to the atmosphere. In some variations of the packaging systems described herein, by reducing the concentration of polyethylene in the polyethylene/maleic anhydride copolymer blend layer increases the migration of moisture from the humidity-inducing product to the functional layers (e.g., EVOH and/or PVOH) and increases the migration of active toward the product. The atmospheric humidity is usually lower which allows the outermost barrier activation layer to absorb less moisture, which preserves its barrier properties to active agent.

In another variation, reducing the permeability of the active agent toward the humidity-inducing product allows for a slower dispensing of the active agent into the atmosphere surrounding the product and reduces the loss of active agent to the atmosphere. This allows the reduction of the amount of active agent deposited between the core structural layers (e.g., LDPE or LLDPE), and reduces the potential cost of the packaging material.

In some embodiments, in the absence of the humidity-inducing product present in the interior space, the active agent does not substantially permeate into the interior space. In some embodiments, the multilayer film constructions do not require the presence of ablations to control the release of the active agent into the interior space when the humidity-inducing product is present in the interior space.

In some embodiments, when (i) the interior space has a moisture level of at least 60% relative humidity, or (ii) the interior space has a relative humidity greater than ambient humidity surrounding the exterior of the system, or both (i) and (ii), the barrier activation layers between the active agent and the interior space lose their barrier properties to the active agent over time, thereby releasing the active agent to the interior space.

### Packaging Systems

In some aspects, described herein are packaging systems for storing a humidity-inducing product. In some embodiments, the system comprises one or more multilayer film constructions. In some embodiments, the system comprises at least two multilayer film constructions configured to provide an interior space around the humidity-inducing product. In some embodiments, the at least two multilayer film constructions are from a single multilayered structure. In some embodiments, the at least two multilayer film constructions are formed by folding a single multilayered structure onto itself. In some embodiments, the at least two multilayer film constructions are from at least two multilayered structures that are identical or symmetric. In some embodiments, the at least two multilayer film constructions are from at least two multilayered structures that are different or asymmetric.

### Manufacturing Methods

In some aspects, the packaging systems described herein (including in the exemplary packaging systems depicted in FIGS. 1, 2A and 2B) may be produced by suitable blown film manufacturing processes. For example, in some embodiments, a multilayer blown film extrusion line is used to manufacture a multilayer film with at least one core structural layer and a barrier layer oriented toward the outside of the bubble. The barrier layer can be adhered to the core layer with a layer of MAH/PE. The bubble is collapsed and active agent is introduced in the interface between the collapsed layers. The film is converted to bags using a standard bag machine that includes a v-folder and side-weld and cut modules. The resulting packaging systems can be filled with any suitable products, such as food, and be sealed or tied (e.g. with a twist tie).

### ENUMERATED EMBODIMENTS

1. A packaging system for storing a humidity-inducing product, comprising:
at least two multilayer film constructions configured to provide an interior space around the humidity-inducing product, wherein each multilayer film construction independently comprises:
   core structural layers, wherein the core structural layers comprise material that is permeable to the active agent at any humidity and/or temperature; and
   barrier activation layers, wherein at least some of the barrier activation layers are moisture-sensitive layers that are in contact with the structural layers, and
active agent, wherein the active agent comprises at least one volatile compound in liquid form, and wherein the active agent is distributed between two multilayer film constructions, at the interface between adjacent core structural layers in the multilayer film constructions; and
wherein, when (i) the interior space has a moisture level of at least 60% relative humidity, or (ii) the interior space has a relative humidity greater than ambient humidity surrounding the exterior of the system, or both (i) and (ii), the barrier activation layers between the active agent and the interior space lose their barrier properties to the active agent over time, thereby releasing the active agent to the interior space.
   2. The system of embodiment 1, wherein the active agent comprises ethyl pyruvate.
   3. The system of embodiment 1 or 2, wherein the core structural layers independently comprise polyethylene or polypropylene, or a combination thereof.
   4. The system of anyone of embodiments 1 to 3, wherein the moisture-sensitive layers independently comprise ethylene vinyl alcohol or polyvinyl alcohol, or a combination thereof.
   5. The system of embodiment 1, wherein the active agent comprises ethyl pyruvate,
wherein the core structural layers independently comprise polyethylene, and
wherein the moisture sensitive layers independently comprise ethylene vinyl alcohol or polyvinyl alcohol, or a combination thereof.
   6. The system of any one of embodiments 1 to 5, further comprising:
a tray holding the product, wherein the multilayer film construction is wrapped around the tray and the product.
   7. The system of any one of embodiments 1 to 5, further comprising:
a container holding the product, wherein the multilayer film construction forms a lid to the container.
   8. The system of embodiment 7, wherein the container is a rigid container.
   9. The system of any one of embodiments 1 to 5, wherein the system is a pouch.
   10. The system of any one of embodiments 1 to 9, wherein at least some other of the barrier activation layers are amphiphilic compatibilizer layers that are positioned between core structural layers and moisture-sensitive layers, such that the core structural layers adhere to the moisture-sensitive layers.
   11. The system of embodiment 10, wherein the amphiphilic compatibilizer layers comprise maleic anhydride copolymer.
   12. The system of embodiment 11, wherein the amphiphilic compatibilizer layers further comprise material that is permeable to the active agent at any humidity and/or temperature.
   13. The system of embodiment 10 to 12, wherein the amphiphilic compatibilizer layers independently comprise a blend of maleic anhydride copolymer and polyethylene.
   14. The system of any one of embodiments 10 to 13, wherein the amphiphilic compatibilizer layers have an average thickness between 1 micron and 10 microns.
   15. The system of any one of embodiments 10 to 14, wherein the outermost barrier activation layer and the innermost barrier activation layer of the multilayer film construction are amphiphilic compatibilizer layers.
   16. The system of any one of embodiments 10 to 14, wherein the outermost barrier activation layer and the innermost barrier activation layer of the multilayer film construction are additional layers comprising material permeable to the active agent at any humidity and/or temperature.
   17. The system of embodiment 16, wherein the outermost barrier activation layer and the innermost barrier activation layer of the multilayer film construction comprise polyethylene.
   18. The system of embodiment 16 or 17, wherein (i) the outermost barrier activation layer has an average thickness between 0.00001 inches and 0.001 inches, or (ii) the innermost barrier activation layer has an average thickness between 0.00025 inches and 0.003 inches, or both (i) and (ii).
   19. The system of embodiment 18, wherein the outermost barrier activation layer has an average thickness between 0.00001 inches and 0.001 inches, and the innermost barrier activation layer has an average thickness between 0.00025 inches and 0.003 inches.
   20. The system of any one of embodiments 1 to 19, wherein the moisture-sensitive layers have an average thickness between 0.5 microns and 25 microns.
   21. The system of any one of embodiments 1 to 20, wherein the average thickness of the barrier activation layers combined is at least 1% of the overall average thickness of the system.
   22. The system of any one of embodiments 1 to 21, wherein each of the core structural layers have an average thickness between 5 microns and 75 microns.
   23. The system of any one of embodiments 10 to 22, wherein ratio of average thickness of the amphiphilic compatibilizer layers adjacent to the moisture-sensitive layers adjacent to core structural layers is between 1:1:15 and 1:1:20.
   24. The system of any one of the preceding embodiments, wherein the average ambient humidity surrounding the exterior of the system is between 50% and 70%.
   25. The system of embodiment 24, wherein the active agent is released to the interior space of the system at a migration rate that is greater than the migration rate at which active agent is released to the surrounding exterior to the system.
   26. The system of any one of the preceding embodiments, wherein the active agent is released into the interior space of the system at a migration rate of at least 0.001 g of active agent/square meter per day.
   27. The system of embodiment 26, wherein the active agent is released into the interior space of the system at a migration rate of between 0.001 g and 10 g of active agent/square meter per day.
   28. The system of any one of the preceding embodiments, wherein the polyethylene is linear low-density polyethylene.
   29. The system of any one of the preceding embodiments, wherein the multilayer film constructions are manufactured by a blown film process.
   30. The system of any one of the proceeding embodiments, wherein the product is a food product.
   31. The system of embodiment 30, wherein the food product is a bakery good, cheese or meat.
   32. The system of embodiment 30, wherein the food product is a loaf of bread.

### EXAMPLES

The following Examples are merely illustrative and are not meant to limit any aspects of the present disclosure in any way.

### Example 1A

Tests were conducted to show that a LLDPE/Adhesive/EVOH film can transmit ethyl pyruvate when subjected to moisture levels over 80% relative humidity. The film tested was observed to lose its barrier properties once the bags were sealed (or twist tied). The relatively humidity inside the bag once sealed (or twist tied) was about 90-97%.

### Example 1B

Additional trials and observations have led to an observation that certain variations of the packaging system involve applying a LLDPE (or other type of PE) on the surface of the EVOH. The polyethylene films allow the migration (diffusion) of moisture, but a significantly reduced rate.

### Example 1C

Tests were also conducted on a construction that had a thin skin of LLDPE (or other PE) on top of the MAH/PE blend layer. This provides for surface properties, such as slip and anti-blocking. The thickness of the outer PE layer affects the rate of permeability of ethyl pyruvate based on the hydration of the EVOH from the interior of the pouch.

### Example 2

The methodology described in this example tests the release of volatile organic liquids (VOL) by various film types under humid conditions. A multitude of small chambers were prepared with an air inlet and outlet including an area in the chamber for a wicking moisture evaporator. A constant flow air pump was attached to the air inlets of all the chambers and the outlets went to atmosphere. After adding water to the wicking evaporators, the air pump was started and we measured the interior humidity in each chamber using humidity sensors. The humidity was measured at 99% constantly over many days.

With each film type, a small 3 inch by 3 inch pouch was prepared by heat sealing the three edges and a tare weight was established. Through the 4^{th} edge of the pouch a measured amount of OVL was inserted. The 4^{th} edge of the pouch was sealed to create a pillow with a known amount of OVL. The pouch was inserted in one of the chambers at day zero. The weight of the pouch was measured once a day until the weight stabilized at a level close to the tare weight of the original pouch.

Film was manufactured with a layer structure of LLDPE/Adhesive/EVOH to demonstrate the film structure in FIG. 1. Pouches were constructed as above and one was placed in a chamber with a controlled humidity of 60% which was accomplished by not including a wicking evaporator. The other pouch was placed in a chamber where the humidity was kept at 99%. As observed in the plots below, the pouch in the higher humidity chamber lost all the OVL by the 15^{th} day after the start of the experiment. The pouch in the 60% humidity chamber lost almost none of the OVL. Table 1 below provides the results of OVL weight loss from film pouches at 99% humidity and 60% humidity for LLPDE/EVOH film.

TABLE 1

| Day | Humidity 99% | Humidity 60% |
|---|---|---|
| 0 | 1.0142 | 1.023 |
| 1 | 1.0197 | 1.005 |
| 2 | 1.0225 | 1.025 |
| 3 | 1.0225 | 1.036 |
| 6 | 0.9635 | 1.022 |
| 7 | 0.942 | 1.015 |
| 8 | 0.9188 | 0.992 |
| 9 | 0.8881 | 1.02 |
| 10 | 0.8495 | 1.023 |
| 14 | 0.7049 | 0.998 |
| 15 | 0.6699 | 0.995 |
| 17 | 0.6578 | 1.024 |
| 21 | 0.6615 | 1.013 |
| 23 | 0.6631 | 1.022 |

### Example 3

In this example, two film types were manufactured: Film 1 in accordance to the system depicted in FIG. 1; and Film 2 in accordance to the system depicted in FIG. 2B. Both films prepared as above and were enclosed in the 99% humidity chambers for many days while their weight loss was recorded. Film 1 lost 0.35 grams of OVL in 10 days while the Film 2 lost 0.35 grams of OVL in 18 days. See results in Tables 2 and 3 below.

TABLE 2

| Day | Weight |
|---|---|
| 0 | 1.0142 |
| 1 | 1.0197 |
| 2 | 1.0225 |
| 3 | 1.0225 |
| 6 | 0.9635 |
| 7 | 0.942 |
| 8 | 0.9188 |
| 9 | 0.8881 |
| 10 | 0.8495 |
| 14 | 0.7049 |
| 15 | 0.6699 |
| 17 | 0.6578 |
| 21 | 0.6615 |
| 23 | 0.6631 |

TABLE 3

| Day | Weight |
|---|---|
| 0 | 1.053 |
| 1 | 1.0484 |
| 2 | 1.0341 |
| 3 | 1.0174 |
| 6 | 0.9686 |
| 14 | 0.8035 |
| 15 | 0.7815 |
| 16 | 0.7632 |
| 17 | 0.7461 |
| 20 | 0.6923 |
| 21 | 0.6722 |
| 23 | 0.6437 |
| 24 | 0.6384 |
| 27 | 0.6424 |
| 28 | 0.6487 |

These results indicate that a skin of LLDPE on top of the EVOH slows down the release of the OVL by slowing down the effect of humidity on the barrier of the EVOH.

1. A packaging system having an interior space for storing a humidity-inducing product, comprising:
at least one multilayer film construction, wherein each multilayer film construction independently comprises:
core structural layers, wherein the core structural layers comprise material that is permeable to the active agent at any humidity and/or temperature; and
barrier activation layers, wherein at least some of the barrier activation layers are moisture-sensitive layers that are in contact with the core structural layers, and
active agent, wherein the active agent comprises at least one volatile compound in liquid form, and wherein the active agent is distributed, at the interface between adjacent core structural layers within each multilayer film construction;
wherein the interior space is formed, at least in part, by the at least one multilayer film construction;
wherein, in the absence of the humidity-inducing product present in the interior space, the active agent does not substantially permeate into the interior space;
wherein each multilayer film construction does not require the presence of ablations to control the release of the active agent into the interior space when the humidity-inducing product is present in the interior space;
wherein, when (i) the interior space has a moisture level of at least 60% relative humidity, or (ii) the interior space has a relative humidity greater than ambient humidity surrounding the exterior of the system, or both (i) and (ii), the barrier activation layers between the active agent and the interior space lose their barrier properties to the active agent over time, thereby releasing the active agent to the interior space.

2. The system of claim 1, wherein the active agent comprises ethyl pyruvate.

3. The system of claim 1, wherein the core structural layers independently comprise polyethylene or polypropylene, or a combination thereof.

4. The system of claim 1, wherein the moisture-sensitive layers independently comprise ethylene vinyl alcohol or polyvinyl alcohol, or a combination thereof.

5. The system of claim 4, wherein the moisture-sensitive layers comprise polyvinyl alcohol, wherein the polyvinyl alcohol is plasticized with one or more hydrophilic materials.

6. The system of claim 5, wherein the one or more hydrophilic materials comprise glycerol or water.

7. The system of claim 4, wherein the moisture-sensitive layers comprises ethylene vinyl alcohol, wherein the ethylene vinyl alcohol comprises between 20 mole % and 40 mole % ethylene.

8. The system of claim 1, wherein the active agent comprises ethyl pyruvate,
wherein the core structural layers independently comprise polyethylene, and
wherein the moisture sensitive layers independently comprise ethylene vinyl alcohol or polyvinyl alcohol, or a combination thereof.

9. The system of claim 1, further comprising:
a tray holding the product, wherein the at least one multilayer film construction is wrapped around the tray and the product, and the interior space is formed between the at least one multilayer film construction and the tray.

10. The system of claim 1, wherein the at least one multilayer film construction is one multilayer film construction, and the system further comprises:
a container holding the product, wherein the multilayer film construction forms a lid to the container, and the interior space is formed between the multilayer film construction and the container.

11. The system of claim 10, wherein the container is a rigid container.

12. The system of claim 1, wherein the at least one multilayer film construction is two multilayer film constructions configured to form a pouch.

13. The system of claim 1, wherein the outermost barrier activation layer and the innermost barrier activation layer of the multilayer film construction are amphiphilic compatibilizer layers.

14. The system of claim 1, wherein the outermost barrier activation layer and the innermost barrier activation layer of the multilayer film construction are additional layers comprising material permeable to the active agent at any humidity and/or temperature.

15. The system of claim 14, wherein the outermost barrier activation layer and the innermost barrier activation layer of the multilayer film construction comprise polyethylene.

16. The system of claim 14, wherein (i) the outermost barrier activation layer has an average thickness between 0.00001 inches and 0.001 inches, or (ii) the innermost barrier activation layer has an average thickness between 0.00025 inches and 0.003 inches, or both (i) and (ii).

17. The system of claim 16, wherein the outermost barrier activation layer has an average thickness between 0.00001 inches and 0.001 inches, and the innermost barrier activation layer has an average thickness between 0.00025 inches and 0.003 inches.

18. The system of claim 14, wherein the additional layers and the core structural layers have substantially the same average thickness.

19. The system of claim 1, wherein at least some other of the barrier activation layers are amphiphilic compatibilizer layers that are positioned between core structural layers and moisture-sensitive layers, such that the core structural layers adhere to the moisture-sensitive layers.

20. The system of claim 14, wherein at least some other of the barrier activation layers are amphiphilic compatibilizer layers that are positioned between core structural layers and moisture-sensitive layers and/or between moisture-sensitive layers and the additional layers, such that the core structural layers adhere to the moisture-sensitive layers and/or the moisture-sensitive layers adhere to additional layers.

21. The system of claim 13, wherein the amphiphilic compatibilizer layers comprise maleic anhydride copolymer.

22. The system of claim 21, wherein the amphiphilic compatibilizer layers further comprise material that is permeable to the active agent at any humidity and/or temperature.

23. The system of claim 13, wherein the amphiphilic compatibilizer layers independently comprise a blend of maleic anhydride copolymer and polyethylene.

24. The system of claim 13, wherein the amphiphilic compatibilizer layers have an average thickness between 1 micron and 10 microns.

25. The system of claim 1, wherein the moisture-sensitive layers have an average thickness between 0.5 micron and 25 microns.

26. The system of claim 1, wherein the average thickness of the barrier activation layers combined is at least 1% of the overall average thickness of the system.

27. The system of claim 1, wherein each of the core structural layers have an average thickness between 5 microns and 75 microns.

28. The system of claim 1, wherein the moisture-sensitive layers comprise nanomers.

29. The system of claim 28, wherein nanomers have plate-like structures.

30. The system of claim 28, wherein at least some of the nanomers are Montmorillonite inorganic clay.

31. The system of claim 28, wherein at least some of the nanomers are precoated.

32. The system of claim 1, wherein the average ambient humidity surrounding the exterior of the system is between 50% and 70%.

33. The system of claim 32, wherein the active agent is released to the interior space of the system at a migration rate that is greater than the migration rate at which active agent is released to the surrounding exterior to the system.

34. The system of claim 1, wherein the barrier activation layers between the active agent and the interior space lose their barrier properties to the active agent over time, thereby releasing the active agent to the interior space when the relative humidity of the interior space is 10% or more higher than the ambient humidity surrounding the exterior of the system.

35. The system of claim 1, wherein the active agent is released into the interior space of the system at a migration rate of at least 0.001 g of active agent/square meter per day.

36. The system of claim 35, wherein the active agent is released into the interior space of the system at a migration rate of between 0.001 g and 10 g of active agent/square meter per day.

37. The system of claim 35, wherein the active agent is released into the interior space at an average rate between 0.1 g/m²/day and 10 g/m²/day in the first 10 days when the interior space has a moisture level of at least 60% relative humidity.

38. The system of claim 35, wherein the active agent is released into the interior space at an average rate between 1 mg/m²/day and 5 mg/m²/day in the first 10 days when the interior space has a moisture level of at least 99% relative humidity.

39. The system of claim 1, wherein the polyethylene is linear low-density polyethylene.

40. The system of claim 1, wherein the multilayer film constructions are manufactured by a blown film process.

41. The system of claim 1, wherein the product is a food product.

42. The system of claim 41, wherein the food product is a bakery good, cheese or meat.

43. The system of claim 41, wherein the food product is a loaf of bread.
